(19) United States
(12) Patent Application Publication
(10) Pub. No.: US 2005/0063271 A1
(43) Pub. Date: Mar. 24, 2005

(54) Optical disk apparatus and pickup driving method thereof

(75) Inventors: Hajime Nishimura, Tokyo (JP); Yoshihiro Fukagawa, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi-LG Data Storage, Inc., Tokyo (JP)

(21) Appl. No.: 10/912,428

(22) Filed: Aug. 4, 2004

(30) Foreign Application Priority Data
Aug. 8, 2003 (JP) 2003-206753

(51) Int. Cl. G11B 5/09

(52) U.S. Cl. 369/53.25; 369/47.36

(57) ABSTRACT

An optical disk apparatus of low consumption of electric power, wherein heat generation is suppressed within a stepping motor for use of drive of a pickup, as one of the heat generation sources, comprises: a pickup 3 for irradiating a laser light upon an optical disk by means of a laser diode; a disk motor for rotating the optical disk mounted thereon; a stepping motor 5 for moving the pickup in the disk radial direction; and a system controller 6 for controlling driving current of the laser diode and rotation speed of the disk motor, as well as, conducting the position control on the pickup through the stepping motor, wherein the stepping motor has a temperature sensor 31 within an inside thereof, and the current to be supplied to the stepping motor is set to be within a predetermined range, so as to control the rotation speed thereof, so that the temperature within an inside is suppressed from increasing, depending upon the temperature detected.

### BACKGROUND OF THE INVENTION

The present invention relates to an optical disk apparatus enabling writing and reading of data through irradiating a laser light upon a circular optical disk, and it relates to, in particular, an optical disk apparatus enabling writing operation of high quality responding to temperature change in the environment where it is used or operated, and also a driving method of a pickup thereof.

For example, with an optical disk apparatus for reading or writing data from/onto an information recording medium, being so-called an “optical disk”, which is a disk-like in the shape thereof and is readable or re-writable (write-in), such as, “CD-R” and/or “CD-RW”, etc., together with speed-up of the disk rotation, and in particular, in the recent years, accompanying with wide spreading of small-sized computers, such as, the notebook-type personal computers, typically, for example, in particular, with the optical disk apparatus to be installed in such the apparatuses, advancement is made on thinness in the size of the apparatus. As a result thereof, within an inside of such the thin-type optical disk apparatus, there are disposed various kinds of parts thereof, being crowded together closely (i.e., being small in the clearance between the parts), for this reason, it is difficult to keep a sufficient space, so that a convection of an air can be obtained for achieving cooling within an inside of the apparatus; thus, it is difficult to disperse the heat generations; such as, that accompanying an emission of laser light within a laser diode, or the like, for example, and/or that accompanying rotation drive of a stepping motor, which builds up a feeder mechanism of an optical pickup, for example.

In this manner, with such the optical disk apparatus, being advanced in the thinness of the sized, in addition to the heat, which is generated in a circuit board for conducting controls upon the laser-light emission and the driving current thereof, the heat generated in a drive LDS, etc., being a circuit board for conducting controls upon rotation of the stepping motor of the feeder mechanism for the optical pickup and the driving current thereof, the heat fills up or staying within an inside of the optical disk apparatus. In particular, for achieving the writing of data upon the optical disk rotating at high speed, a higher laser power is needed, and therefore, the temperature easily comes up high within the inside of the apparatus.

Accompanying with such the speed-up of the disk rotation and also the thinness of the optical disk apparatus as was mentioned above, in particular, for the optical disk apparatus, which is re-writable of data onto the optical disk, it is necessary to enhance the laser light to be higher, further in the power thereof, when conducting the writing upon the optical disk, however with a semiconductor laser device, such as, a laser diode or the like, for example, which is normally adopted as a generation source of the laser light in the optical disk apparatus, there is a limit in the output thereof; therefore, a possibility is caused that the semiconductor laser itself breaks down when trying to output a laser light of a power higher than a rated output thereof. For this reason, since it is not preferable to be high on the temperature within the inside of the apparatus, of course, for suppressing or lowering the heat generated by the semiconductor laser, such as, the laser diode, etc., it is further demanded to provide a driving method enabling to suppress the temperature within the apparatus as low as possible, also about the stepping motor, which builds up the feeder mechanism of the optical pickup, i.e., being one of the heat generation sources, while fitting to the environment where it is applied (in particular, the temperature within the apparatus). In addition thereto, it is also demanded to provide an optical disk apparatus of being low in the consumption of electric power, in relation to the lifetime of a buttery, used as the electric power thereof, even in a case of seeing it from a viewpoint of the personal computer, which installs such the thin-type optical disk apparatus therein generally.

However, conventionally within such the optical disk apparatus as was mentioned above, there is already known a traverse driving mechanism, in the Patent Document 1, for example, which will be mentioned below, as a traverse driving apparatus, adopted to be so-called the feeder mechanism for the optical pickup, for the purpose of obtaining an operation/performance of being always stable in spite of changes in the temperature of the environment where it is used, comprising a temperature detecting means for detecting the temperature of the environment where it is used, and thereby being supplied with an appropriate driving power even if the driving load is changed due to the change of temperature.

Patent Document 1: Japanese Patent Laying-Open No. Hei 9-306127 (1997).

Also, in the Patent Document 2 which will be mentioned below, there is already known a circuit, in which current circuits for rotationally driving a motor of the optical disk apparatus are unified or put into one (1) chip of an integrated circuit (IC), which are conventionally built up with plural numbers of transistors, etc., and further there is provided a temperature detection means for detecting the chip temperature for protecting it from the thermal breakdown, etc., effectively; i.e., so as to change a motor limit signal, gradually, accompanying with an increase of the chip temperature detected, and thereby achieving a limit revision operation of bringing the current limit value of the motor to be small, depending upon the motor limit signal.

Patent Document 2: Japanese Patent Laying-Open No. Hei 11-146681 (1999).

Further, there is also already known a mechanism, in the optical disk apparatus, being free from ill influences of changing in a mechanism load of the traverse mechanism, due to wear of the constituent parts and/or the change of temperature thereof, as well as, suppressing generation of a delay, which is caused in a normal operation due to a learning operation of the mechanism load, in the Patent Document 3 which will be mentioned blow.

Patent Document 3: Japanese Patent Laying-Open No. 2002-352447 (2002).

### BRIEF SUMMARY OF THE INVENTION

However, with such the various optical disk recording apparatuses relating to the conventional arts mentioned in the above, still it is not always possible to obtain an effect of fully suppressing or lowering the temperature, in particular, in the optical disk apparatus of the thin-type, in which the temperature can easily rise up within an inside thereof.

For example, with the traverse driving mechanism known in the Patent Document 1 mentioned above, in which an appropriate driving force can be supplied in spite of changing of the driving load thereupon due to the change of temperature, though a stepping height of the pulse voltage applied to a traverse motor is set at, appropriately, depending upon the temperature detected, however, only due to this, the torque generated by the motor is reduced down, and therefore, the feeder comes to be unstable in the operation. And, with such the structure of achieving the limit revision operation, so as to make the motor current limit value small, which is already known in the Patent Document 2 mentioned above, also the torque generated by the motor is reduced down, thereby bringing the feeder into the operation of being unstable.

Further, with the mechanism shown in the Patent Document 3 mentioned above, wherein suppression is made upon the generation of delay in the normal operation due to the learning operation of the mechanism load, it is impossible to obtain an effect of suppressing the temperature with sufficiency, always, in particular, within the optical disk apparatus of the thin-type structure, in which the temperature can rise up easily within an inside thereof.

Then, according to the present invention, achieved by taking the drawbacks mentioned above into the consideration, i.e., in the optical disk apparatus, within which the heat generated fills up or stays within an inside, and therefore the temperature can easily rises up within the inside thereof, in particular, within the apparatus of the thin-type, for example, it is an object to provide an optical disk apparatus, having a low heat generation and also a low consumption of electric power, wherein the heat generation can be suppressed or lowered, effectively, in particular, within the stepping motor for use of driving the pickup, as one of the heat generation sources in the optical disk apparatus, while fitting to the environment where it is used or operated, and also keeping the functions and the operations necessary for the apparatus.

For accomplishing the object mentioned above, according to the present invention, there is provided an optical disk apparatus, at least comprising: a pickup having a semiconductor laser device for generating a laser light for writing of data; a disk driving portion mounding a disk thereon, onto which the writing of data is conducted, and for rotationally driving thereof; a moving mechanism portion, having a stepping motor therein, for moving said pickup into a radial direction of said optical disk mounted on said disk deriving portion; and a controller portion for supplying driving current to said semiconductor laser device, and for controlling rotational speed of said disk driving portion, as well as, movement on position of said pickup portion by means of said pickup moving mechanisms portion, and further comprising a temperature sensor therein for detecting temperature within an inside of said apparatus, wherein: said controller means sets the current to be supplied to the stepping motor of said pickup moving mechanism portion at a value within a predetermined region thereof, depending upon the temperature detected by said temperature sensor, and also controls the rotation speed of said stepping motor, depending upon the temperature provided from said temperature sensor, so that the temperature is suppressed from increasing within the inside of said apparatus.

Further, according to the present invention, in the optical disk apparatus described in above, preferably, said controller means sets up a permissible upper limit value and a permissible lower limit value within the predetermined region of the current to be supplied to the stepping motor of said moving mechanism portion, depending upon the temperature detected by said temperature sensor, and further, said controller means sets up the current to be supplied to the stepping motor of said moving mechanism portion between the permissible upper limit value and the permissible lower limit value within the predetermined range of said current. Furthermore, preferably, said controller means sets up the current depending upon temperature detected by means of said temperature sensor when setting up the current to be supplied to the stepping motor of said moving mechanism portion between the permissible upper limit value and the permissible lower limit value within the predetermined range of said current.

Also, according to the present invention, in the optical disk apparatus described in the above, preferably, said controller means further control a rotation speed of said stepping motor depending upon the temperature detected by means of said temperature sensor, accompanying with rotation drive of said stepping motor of said pickup moving mechanism portion, and preferably, the optical disk apparatus, into which the present invention is applied, is equal to 10 mm or less than that in a size thereof, in a direction of thickness.

In addition to the above, according to the present invention, there is also provided a pickup driving method for moving/controlling a position of a pickup portion of an optical disk apparatus, having: a pickup having a semiconductor laser device for generating a laser light for writing of data; a disk driving portion mounding a disk thereon, onto which the writing of data is conducted, and for rotationally driving thereof; and a moving mechanism portion, having a stepping motor therein, for moving said pickup into a radial direction of said optical disk mounted on said disk deriving portion, thereby moving and controlling at least the position of said pickup portion through said pickup moving mechanism portion by a controller means, and said apparatus further comprises a temperature sensor for detecting temperature within an inside of said apparatus, wherein said method comprising the following steps of: setting up current to be supplied to the stepping motor of said pickup moving mechanism portion at a value within a predetermined region thereof, depending upon the temperature detected by said temperature sensor; and controlling the rotation speed of said stepping motor, depending upon the temperature detected, so that the temperature is suppressed from increasing within the inside of said apparatus.

Also, according to the present invention, in the pickup driving method described in the above, preferably, a permissible upper limit value and a permissible lower limit value are set up within the predetermined region of the current to be supplied to the stepping motor of said moving mechanism portion, depending upon the temperature detected by said temperature sensor, further, the current to be supplied to the stepping motor of said moving mechanism portion is set up between the permissible upper limit value and the permissible lower limit value within the predetermined range of said current, and further, the current is set up depending upon temperature detected by means of said temperature sensor when setting up the current to be supplied to the stepping motor of said moving mechanism portion between the permissible upper limit value and the lower limit value within the predetermined range of said current. Or, according to the present invention, in the pickup driving method described in the above, preferably, further the rotation speed of said stepping motor is controlled depending upon the temperature detected by means of said temperature sensor, accompanying with rotation drive of said stepping motor of said pickup moving mechanism portion.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIGS. 1(a) and 1(b) show flowcharts for showing a method of conducting a driving/controlling upon a pickup in an optical disk apparatus, according to one embodiment of the present invention;

FIG. 2 is a block diagram for showing a brief structure of the optical disk apparatus mentioned above, according to the one embodiment of the present invention;

FIG. 3 is a view for explaining a principle of the driving method on the pickup mentioned above, according to the present invention, and in particular, of showing a relationship between circumference temperature of a drive and a pickup torque load;

FIG. 4 is also a view for explaining the principle of the driving method on the pickup mentioned above, according to the present invention, and in particular, of showing a relationship between a motor rotation speed, a motor torque and driving current, in a stepping motor;

FIG. 5 is a view for explaining an operation of an each portion in the optical disk apparatus mentioned above, according to the present invention; and

FIG. 6 is also a view for explaining the operation of an each portion in the optical disk apparatus mentioned above, according to the present invention.

### DETAILED DESCRIPTION OF THE INVENTION

Hereinafter, embodiments according to the present invention will be fully explained by referring to the attached drawings.

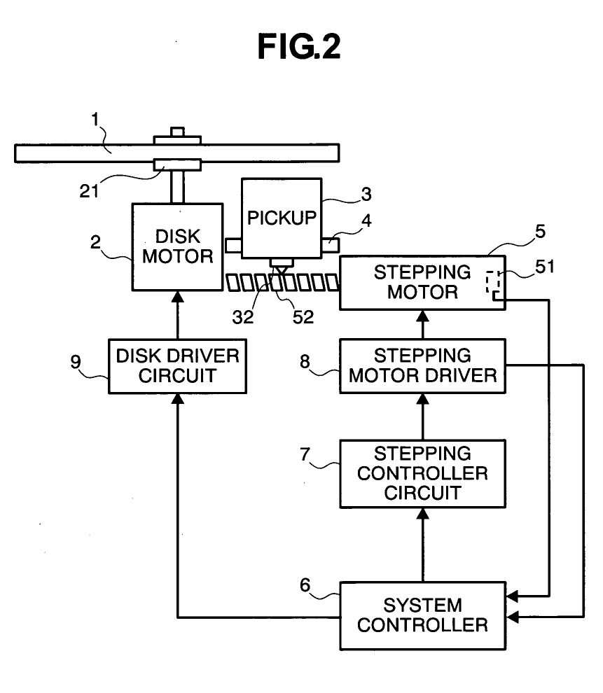

First of all, FIG. 2 attached herewith is a block diagram for showing an internal structure of the optical disk apparatus according to an embodiment of the present invention. In this figure, a reference numeral 1 depicts a disk-like information-recording medium, being so-called an optical disk, on which recording or re-writing (hereinafter, being called by “writing”, collectively) can be made, such as, CD-R or CD-RW, etc., for example. Further, as is shown in the figure, this optical disk 1 is detachably mounted on a turn table 21, which is attached at a tip of a rotation shaft of a disk motor 2, being provided for rotationally driving the said optical disk; thereby conducting the writing of data under the condition of being mounted thereon.

Also, a reference numeral 3 in the figure depicts a pickup for conducting recording or reproducing of information onto or from the optical disk 1, in particular, the information signal surface thereof, which is mounted on the turn table to be driven rotationally, while irradiating a beam of laser light thereupon under the condition of being focused thereupon, and this pickup 3, as being a recording/reproducing means, is attached, to be movable, freely, in the radial direction of the optical disk 1, through a guide means 4, such as, a guide shaft or the like, for example.

Further, in this FIG. 2, a reference numeral 9 depicts a disk driver circuit for driving/controlling the disk motor 2, which rotationally drives the optical disk 1 at a predetermined rotation speed. On the other hand, the pickup 3 mentioned above is connected onto a spiral shaft 52, in a slidable manner, at a tip of a lower portion thereof, which shaft is connected to the rotation shaft of the stepping motor 5; thereby being freely movable at a predetermined position in the radial direction of the optical disk 1 through the control on rotation of the stepping motor 5 mentioned above. Also, a reference numeral 7 in the figure depicts a stepping controller circuit for controlling rotation of the stepping motor 5, and a reference numeral 8 depicts a stepping motor driver for supplying driving current for the stepping motor, depending upon a control output from the stepping controller circuit 7. Further, within an inside of the stepping motor 5, there is provided a temperature sensor 51, being made of an element of temperature sensitive resistance or the like, for detecting an ambient or circumference temperature, so as to output a signal of electric potential level corresponding thereto.

Moreover, the temperature detection signal from the temperature sensor 51, which is provided within an inside of the stepping motor 5, is inputted into a system controller 6 together with a signal from the stepping motor driver 8 mentioned above. On the other hand, the system controller 6 executes the control upon various operations, including the positioning of the pickup 3 in the radial direction, driving the light emission of a laser diode, and so on, and at the same time, it drives the disk motor 2 so as to controls the rotation speed thereof, through the disk driver circuit 9 mentioned above, and also controls the driving current of the stepping motor 5 through the stepping controller circuit 7 and/or the stepping motor diver 8 mentioned above.

However, though not illustrating in more details thereof, as was mentioned above, accompanying with such the demand for the optical disk apparatus, in particular, for a portable type of the optical disk apparatus, in the recent years, a request from the markets is high, especially, for the thin-type disk apparatus; such as, being equal 10 mm or less than that in thickness of the apparatus (for example, being 9.5 mm. However, at the present, it is 9 mm at the lower limit, from a viewpoint of designing thereof). As a result thereof, fundamental element parts for building up the optical disk apparatus mentioned above, and also other parts to be mounted depending upon the necessity thereof, they are disposed, appropriately, within such the very thin (or narrow) space, such as, being equal to 10 mm or less than that in the thickness thereof. On the other hand, also the optical disk 1, normally having the thickness of 1.2 mm or more or less and to be installed into the inside thereof in a removable manner, is rotated within such the thin (or narrow) space (i.e., within the narrow clearance defined between various kinds of the parts thereof), at high rotation speed. And, the heart generated in the drive LDS, being a circuit substrate for conducting control upon emission of the laser light and the driving current thereof, and further in the stepping motor 5 mentioned above, fills up and stays within an inside of the optical disk apparatus, and for this reason, as was mentioned in the above, the temperature can easily raises up within the inside thereof.

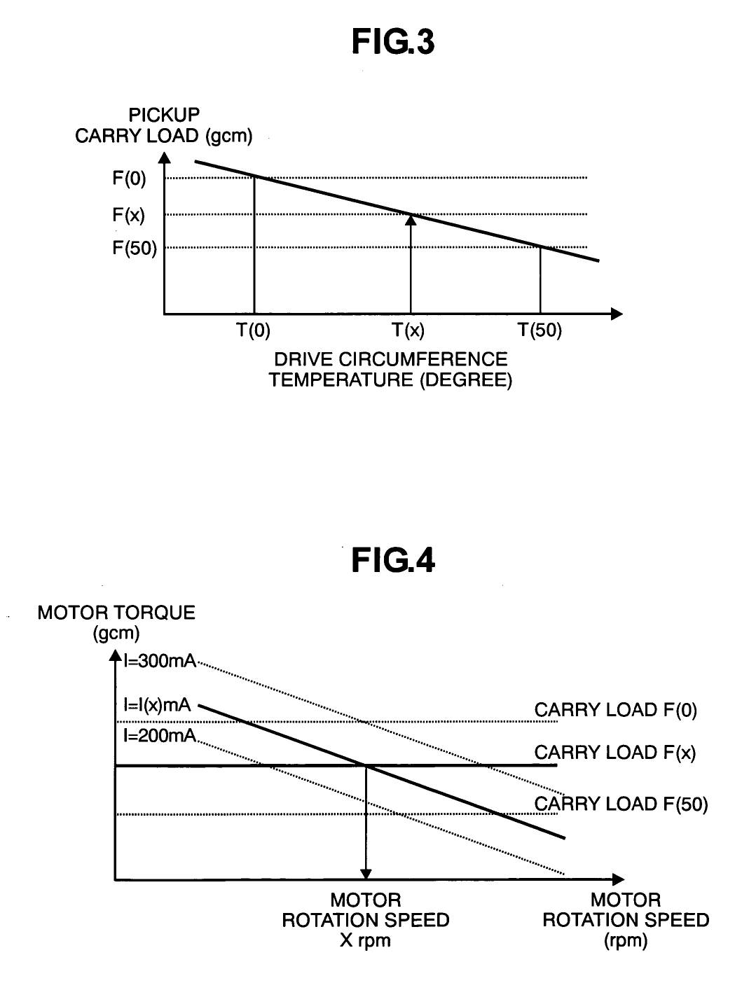

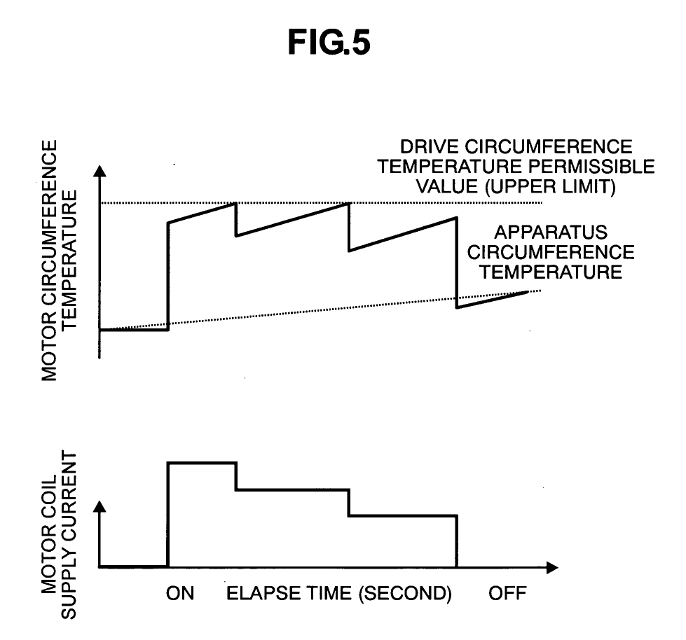

Next, hereinafter, explanation will be given about the driving principle, in particular, of the stepping motor for driving the pickup, in the optical disk apparatus according to the present invention, the structure of which is shown in the above, by referring to FIGS. 3 and 4 attached.

First of all, when the pickup 3 is moved freely along with the guide means 4, i.e., in the radial direction of the optical disk 1 which is mounted on the turntable 21 of the disk motor 2, the spiral shaft 52 is rotated, on which a tip of the lower end portion 32 of the pickup 3 is connected with, in a slidable manner, however in FIG. 3 attached herewith, there is shown a relationship between the pickup carry load (gcm) necessary for the stepping motor 5 at the time when rotationally driving the spiral shaft 52 and the circumference temperature of such the driving mechanism “T” (i.e., the drive circumference temperature). However, herein the circumference temperature of the driving mechanism may be the temperature, which is detected by means of a temperature sensor 51 provided within an inside of the stepping motor 5, for example.

As is apparent from the graph shown in the figure, the pickup carry load, being necessary for, shows a tendency that it comes down (F(0)→F(x)→F(50)), as the drive circumference temperature “T” rises up (T(0)→T(x)→T(50)). Namely, it can be seen therefrom, that the motor torque generated by the stepping motor 5 can be lowered down in accordance with an increase of the drive circumference temperature “T”.

Next, FIG. 4 attached herewith shows a relationship between the motor torque (gcm) and the motor rotation speed (rpm) on the stepping motor 5 mentioned above. Namely, as is apparent from this graph, it can be seen that, in general, the motor torque generated therefrom reduces in an inverse proportion to an increase of the motor rotation speed. However, in this graph, the relationship between the motor torque and the motor rotation speed is depicted with using current “I” supplied to the motor coil as a parameter thereof (such as, I=300 mA, I=x mA, I=200 mA, for example), and from this, it can be seen that the motor torque (gcm) generated from the stepping motor 5 mentioned above also changes depending upon the current “I” supplied to the motor coil thereof.

Also, in this FIG. 4, there is shown the feed loads F(0), F(x) and F(50) at the respective drive circumference temperatures “T”s shown in FIG. 3 mentioned above, by three (3) pieces of horizontal lines. For example, in a case where the drive circumference temperature of the apparatus at the present is “x” degree, for example, the feed load necessary to be generated by means of the stepping motor 5 comes to be F(x). Then, for example, if setting the current “I” to be supplied to the motor coil at I=x mA, it is possible to obtain the motor rotation speed X (rpm). Also, in this instance, changing the current “I” supplied to the motor (coil), while fluctuating it from I=x mA mentioned above (however, setting the supply current I=200 mA at the lower limit and I=300 mA at the upper limit thereof), it also causes a change on the motor rotation speed “X” at that time, simultaneously, however it is indicated that the necessary motor torque can be obtained.

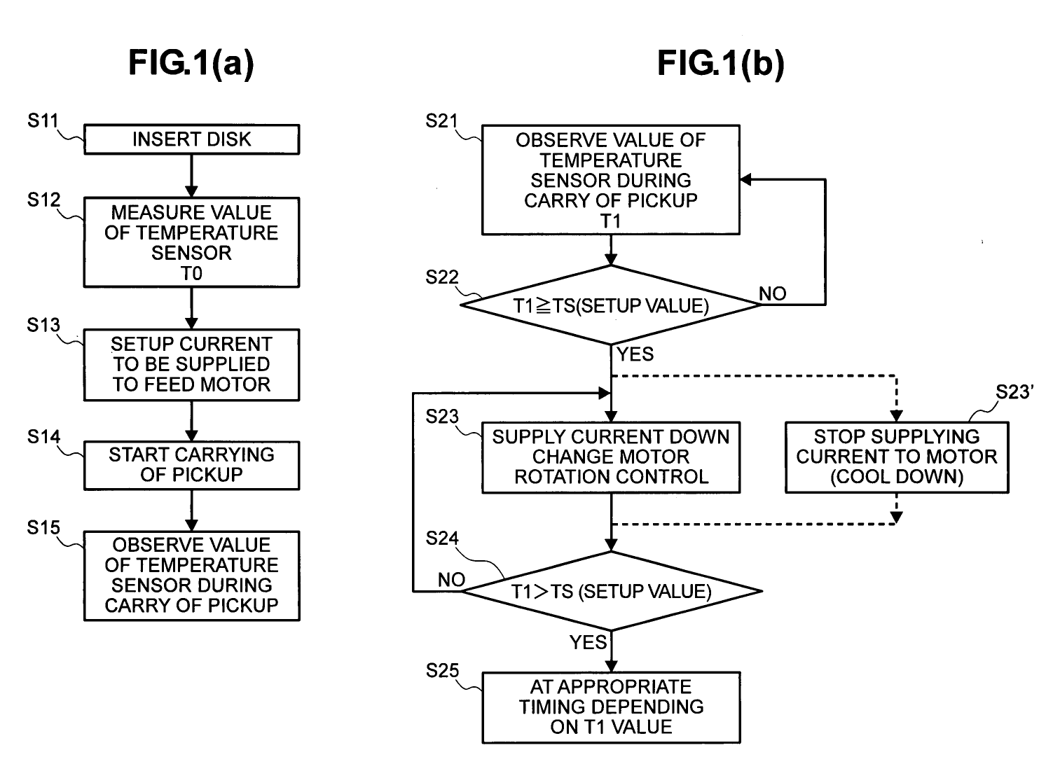

Following to the above, hereinafter, explanation will be give in more details thereof, about the method for conducting a drive control upon the pickup within the optical disk apparatus shown in FIG. 2 mentioned above, according to the present invention, while applying the driving principle of the stepping motor explained in the above, by referring to the flowchart shown in FIGS. 1(a) and 2(b) attached herewith. However, the operation which will be explained hereinafter is assumed to be executed, by starting a software memorized within an inside of the system controller 6 mentioned above, which is built up with a CPU or the like, for example, in the structure of the optical disk apparatus shown in FIG. 2 mentioned above.

First in FIG. 1(a), it is detected that the disk is inserted into the optical apparatus (i.e., when the optical disk 1 is mounted on the turntable 21a and then a cover is closed, detecting it by using a switch, for example) (step S11), and then measurement is made on the value (T0) of the temperature sensor (step S12). However, in this instance, the measurement may be made by using the temperature sensor 51 provided within the inside of the stepping motor 5 mentioned above, as the temperature sensor, or alternately, by providing other temperature sensor in the place thereof (but, within an inside of the housing of the optical disk apparatus). Thereafter, upon the basis of this temperature “T0” detected, the current is set up to be supplied to the stepping motor 5, as being the feeder motor of the pickup (step S13).

However, in the step of setting up the current to be supplied, the upper limit value and the lower limit value thereof are also set up, with using the characteristics of the stepping motor, which are shown in FIG. 4 mentioned above. For example, in the actual optical apparatus, it is undesirable that the moving speed of the pickup comes down to be slow too much, since it also causes delays in the operation of the apparatus, as a whole. Then, the lowest moving speed necessary for the pickup 3 is obtained, in advance, so as to obtain the lowest rotation speed necessary for the stepping motor corresponding thereto. Thus, the lowest rotation speed obtained in this manner enables to determine the lowest value of the current “I” to be supplied, being necessary for generating the motor torque, from the relationship between the feed loads “F” necessary for the respective drive circumference temperatures.

On the other hand, in general, the upper limit value of the current “I” to be supplied to the motor coil can be determined for each of the drive circumference temperatures, experimentally, since the heat generation of the motor comes to be large, as the current goes up in the value thereof. Further, it is preferable for those upper limit value and lower limit value of the current to be supplied to the motor coil, to be obtained, experimentally, for example, and then- to be stored within, such as, the RAM or the ROM, for example, so that they can be read out for setting up, by using the temperature “T” detected through the temperature sensor mentioned above as the parameter thereof.

Following to the above, the optical disk apparatus starts the feeder operation of the pickup (step S14), and thereafter it conducts an observe operation upon the value of the temperature sensor during the time-period when carrying the pickup (step S15).

Next, the details are shown in FIG. 1(b), of the observe operation upon the value of the temperature sensor during the time-period when carrying the pickup in the step S15 mentioned above. Namely, observation is made upon the value “T1” of the temperature sensor during the feed operation of the pickup (step S21), and the detected value “T1” of the temperature sensor is compared to the setup value “TS” which is determined in advance (step S22). However, this setup value “TS” is determined, by taking the various operations of the apparatus, as a whole, for example, into the consideration; thus, the temperature of the upper limit is determined, to be permissible in the circumferences of the stepping motor mentioned above, by taking the temperature dependency of a semiconductor laser, such as a laser diode, etc., into the consideration, for example.

As a result of the comparison made in the step S22 mentioned above, if it is in a case that the observed value “T1” of the temperature sensor does not exceed the setup temperature “TS” mentioned above (i.e., in the case of “No” in the figure), then the process turns back to the step S21 mentioned above, again. On the other hand, if the observed value “T1” of the temperature sensor exceeds the setup temperature “TS” (i.e., in the case of “Yes”), the current “I” supplied to the motor coil is reduced, thereby changing the motor rotation control (step S23). Namely, as is shown in FIG. 4 mentioned above, for example, in the case where the drive circumference temperature is “x” degree and the feed load is F(x), being necessary for the motor, and if the current I=300 mA is supplied to the stepping motor 5, first, then the current is reduced down to I=I(x). Accompanying with this, the rotation speed of the stepping motor 5 falls down.

Thereafter (after elapsing a time-period of several seconds, for example), the process compares the observed value “T1” of the temperature sensor to the setup temperature “TS”, again (step S24), thereby confirming that the value “T1” of the temperature sensor falls down to be smaller than that of the setup temperature “TS”. However, in a case where the value “T1” of the temperature sensor does not comes to be smaller than that of the setup temperature “TS” (i.e., in the case of “No” in the figure), the process turns back to the step S23 mentioned above, again, thereby lowering the current “I” to be supplied to the motor coil and thereby changing the motor rotation control thereof. For example, in FIG. 4 mentioned above, the current “I” being supplied to the stepping motor 5 is lowered down to I=I(x) mA, and further down to I=200 mA.

By the way, as was mentioned previously, the current “I” to be supplied to the motor coil is determined in the step S13 shown in FIG. 1(a) mentioned above, at the lower limit value thereof. From this fact, according to the driving method of the pickup of the present invention, i.e., the driving method of the stepping motor, the current “I” to be supplied to the motor coil is reduced accompanying the increase of the temperature within the apparatus, thereby lowering the rotation speed thereof, however due to the lower limit value of the current “I” to be supplied, it is always possible to maintain the motor torque and the rotation speed at the values necessary for feeder drive of the pickup, from the relationship between the feed load “F”.

And, thereafter, in a case where the value “T1” of the temperature sensor is smaller than the setup temperature “TS” (i.e., in the case of “Yes” in the comparison of the step S24), the process repeats the operation mentioned above, at an appropriate timing depending upon the value “T1” of the temperature sensor (i.e., at an appropriate frequency, as was mentioned above) (step S25). However, in the case where the value “T1” of the temperature sensor does not fall down to be smaller than the setup temperature “TS” in spite of reducing the current supplied to the motor coil (i.e., in the case of “No” in the step S24), or alternately in the place of the step S23 mentioned above, it is possible to stop the current to be supplied to the stepping motor 5, as shown in the figure, for example, thereby achieving the cooling down of the motor.

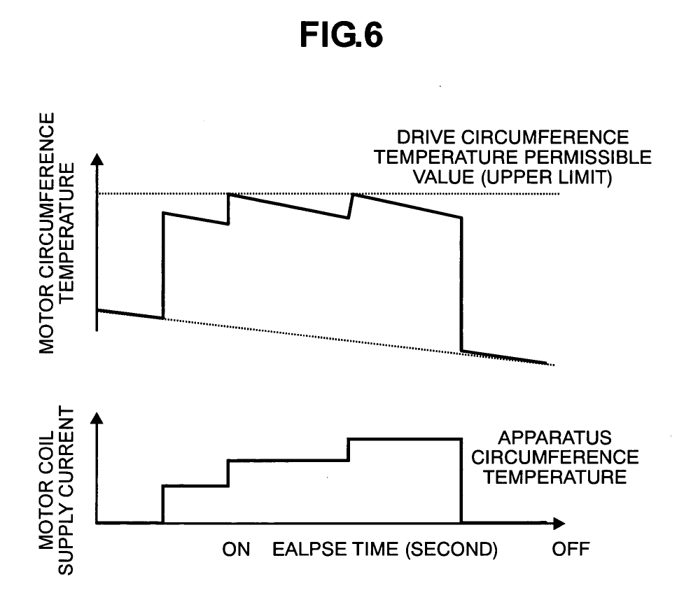

Following to the above, explanation will be given about the operation of an each portion in the optical disk apparatus, according to the present invention, the process in which was explained in the above, by referring to FIGS. 5 and 6 attached. FIG. 5 shows the case where the circumference temperature of the optical disk apparatus goes up, gradually, while on the contrary to the above, FIG. 6 shows the case where the circumference temperature of the optical disk apparatus falls down gradually, respectively.

As is apparent from this FIG. 5, in particular, in the case where the circumference temperature goes up, gradually, within the optical disk apparatus, then the circumference temperature of the motor raises up, gradually, when the driving current is supplied into the motor coil of the stepping motor. However, when the temperature reaches up to a permissible value (an upper limit) of the motor circumference temperature, then the current flowing through the motor coil is reduced down, gradually, and-as a result thereof, the motor circumference temperature is so controlled that it will not exceed the permissible value (i.e., the upper value) of the motor circumference temperature.

On the other hand, as is apparent from FIG. 6, in particular, when the circumference temperature thereof falls down, gradually, within the optical disk apparatus, then the circumference temperature of the motor raises up, gradually, when the driving current is supplied into the motor coil of the stepping motor. However, since the temperature does not reach to the permissible value (i.e., the upper value) of the motor circumference temperature; therefore, though the driving current supplied into the motor coil is increased, however it will not exceeds the permissible value (i.e., the upper value) of the motor circumference temperature, of course.

As was mentioned above, with the optical disk apparatus according to the present invention, since it is possible to control the driving current to be supplied into the coil of the stepping motor mentioned above, in a suitable manner, in spite of fluctuation of the circumference temperature, i.e., the environment where it is used or operated, but it is possible to suppress the heat generation within the stepping motor, thereby enabling to maintain the functions and the operations necessary for the apparatus, as a whole, at the maximum thereof, but without letting the temperature in the apparatus to exceed over the upper limit permissible, with certainty. If applying this, in particular, into the optical disk apparatus of the thin-type, in which the heat can fill up and stays within the inside of the apparatus, it is possible to obtain the effect, much more.

However, in the embodiment mentioned above, the current value “I” of the driving current, which is supplied to the motor coil of the stepping motor, is set at the value, as an initial value thereof, in the middle of the upper limit value and the lower limit value (i.e., =(upper limit value+lower limit value)/2), which are determined in the step S 13 shown in FIG. 1 mentioned above. However, according to the present invention, this initial driving current value “I” may be also determined, appropriately, within a range between the upper limit value and the lower limit value, which are determined in the above. Or, alternately, it is possible to determine it with using the temperature “T0” that is detected at that time. For example, it would be preferable that, in a case where the temperature “T0” detected is relatively high, then the current value “I” of the initial driving current is set to be relatively low, on the other hand, in the case where the temperature “T0” detected is relatively low, this driving current is set at a relatively high value.

Further, in the above, the explanation was given only about the CD-Rand/or the CD-RW, as the optical disk, i.e., the disk-like information recoding medium, on which data can be written with using the optical disk apparatus according to the present invention, however, it is needless to say that the present invention should not be limited only to those, but further, it may be also applicable to an optical disk apparatus, with which data can be written onto a writable optical information recording disk, such as, being generally so-called a “DVD” disk, for example, in the similar manner.

As apparent from the detailed explanation given in the above, with the optical disk apparatus and the method for driving the pickup thereof, according to the present invention, it is possible to provide an optical disk apparatus of low consumption of electric power, but maintaining the functions and the operations necessary for the apparatus, with suppressing or lowering the heat generation within the stepping motor for use of driving the pickup, as one of the heat generation sources on the optical disk apparatus, depending upon the temperature within the inside thereof, so that it fits to the environment where it is used or operated. For that reason, with the optical disk apparatus and the method for driving the pickup thereof, according to the present invention, it is possible to obtain an effect being superior, in particular, when being applied into the optical disk apparatus of the thin-type, or the like, having the structure, in which the heat generated can be easily filled up with or stay therein, so that the temperature can easily goes up within the inside thereof.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

1. An optical disk apparatus, at least comprising:
a pickup having a semiconductor laser device for generating a laser light for writing of data;
a disk driving portion mounding a disk thereon, onto which the writing of data is conducted, and for rotationally driving thereof;
a moving mechanism portion, having a stepping motor therein, for moving said pickup into a radial direction of said optical disk mounted on said disk deriving portion; and
a controller portion for supplying driving current to said semiconductor laser device, and for controlling rotational speed of said disk driving portion, as well as, movement on position of said pickup portion by means of said pickup moving mechanisms portion, and further comprising a temperature sensor therein for detecting temperature within an inside of said apparatus, wherein:
said controller means sets the current to be supplied to the stepping motor of said pickup moving mechanism portion at a value within a predetermined region thereof, depending upon the temperature detected by said temperature sensor, and also controls the rotation speed of said stepping motor, depending upon the temperature provided from said temperature sensor, so that the temperature is suppressed from increasing within the inside of said apparatus.

2. The optical disk apparatus, as described in the claim 1, wherein said controller means sets up a permissible upper limit value and a permissible lower limit value within the predetermined region of the current to be supplied to the stepping motor of said moving mechanism portion, depending upon the temperature detected by said temperature sensor.

3. The optical disk apparatus, as described in the claim 2, wherein said controller means sets up the current to be supplied to the stepping motor of said moving mechanism portion between the permissible upper limit value and the permissible lower limit value within the predetermined range of said current.

4. The optical disk apparatus, as described in the claim 3, wherein said controller means sets up the current depending upon temperature detected by means of said temperature sensor when setting up the current to be supplied to the stepping motor of said moving mechanism portion between the permissible upper limit value and the permissible lower limit value within the predetermined range of said current.

5. The optical disk apparatus, as described in the claim 1, wherein said controller means further control a rotation speed of said stepping motor depending upon the temperature detected by means of said temperature sensor, accompanying with rotation drive of said stepping motor of said pickup moving mechanism portion.

6. The optical disk apparatus, as described in the claim 1, wherein said optical disk apparatus is equal to 10 mm or less than that in a size thereof, in a direction of thickness.

7. A pickup driving method for moving/controlling a position of a pickup portion of an optical disk apparatus, having:
a pickup having a semiconductor laser device for generating a laser light for writing of data;
a disk driving portion mounding a disk thereon, onto which the writing of data is conducted, and for rotationally driving thereof; and
a moving mechanism portion, having a stepping motor therein, for moving said pickup into a radial direction of said optical disk mounted on said disk deriving portion, thereby moving and controlling at least the position of said pickup portion through said pickup moving mechanism portion by a controller means, and said apparatus further comprises a temperature sensor for detecting temperature within an inside of said apparatus, wherein said method comprising the following steps of:
setting up current to be supplied to the stepping motor of said pickup moving mechanism portion at a value within a predetermined region thereof, depending upon the temperature detected by said temperature sensor; and
controlling the rotation speed of said stepping motor, depending upon the temperature detected, so that the temperature is suppressed from increasing within the inside of said apparatus.

8. The pickup driving method, as described in the claim 7, wherein a permissible upper limit value and a permissible lower limit value are set up within the predetermined region of the current to be supplied to the stepping motor of said moving mechanism portion, depending upon the temperature detected by said temperature sensor.

9. The pickup driving method, as described in the claim 8, wherein the current to be supplied to the stepping motor of said moving mechanism portion is set up between the permissible upper limit value and the permissible lower limit value within the predetermined range of said current.

10. The pickup driving method, as described in the claim 9, wherein the current is set up depending upon temperature detected by means of said temperature sensor when setting up the current to be supplied to the stepping motor of said moving mechanism portion between the permissible upper limit value and the lower limit value within the predetermined range of said current.

11. The pickup driving method, as described in the claim 7, wherein further the rotation speed of said stepping motor is controlled depending upon the temperature detected by means of said temperature sensor, accompanying with rotation drive of said stepping motor of said pickup moving mechanism portion.
